(19) United States
(12) Patent Application Publication
(10) Pub. No.: US 2016/0347226 A1
(43) Pub. Date: Dec. 1, 2016

(54) Passenger-Friendly Attachable Waste Receptacle

(71) Applicant: Patsy Hartley Eubank, Disputanta, VA (US)

(72) Inventor: Patsy Hartley Eubank, Disputanta, VA (US)

(21) Appl. No.: 15/092,553

(22) Filed: Apr. 6, 2016

Related U.S. Application Data
(60) Provisional application No. 62/143,765, filed on Apr. 6, 2015.

(51) Int. Cl. B60N 3/08; B60R 7/04; B65F 1/06

(52) U.S. Cl. CPC B60N 3/08; B65F 1/06; B60R 7/043

(57) ABSTRACT

The present invention is a passenger-friendly attachable waste receptacle. The purpose of the invention is to inspire a passenger of a car or other vehicle to independently dispose of trash in an easy and convenient way, without the help of a driver, in an accessible receptacle that is attachable to the back of a seat or other stationary part of a vehicle. The receptacle is ideally attractive in design, may contain pockets to store additional clean-up items, and is designed to be placed within easy reach of a passenger, to encourage clean up.

### CROSS-REFERENCE TO RELATED APPLICATIONS

This non-provision utility patent application claims priority to U.S. provisional patent application No. 62/143,765.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of WASTE RECEPTACLES. More particularly, the present invention is in the technical field of ATTACHABLE WASTE RECEPTACLES. More particularly, the present invention relates to PASSENGER-FRIENDLY ATTACHABLE WASTE RECEPTACLES.

Historically, waste receptacles have been designed to allow for ease of disposal of items no longer needed for use by the individual who is disposing of the item. Several versions exist, including stand up containers, hanging bins, step-cans, and versions that may be inserted into cabinets and pulled out by means of wheels on a rack, attached.

All of these inventions relate to a relatively stationary location for the waste receptacle; i.e., on a bathroom floor or in a kitchen cabinet or closet. These designs do not take into account the need for useful waste receptacles that may be kept in automobiles or other modes of transportation, to allow a passenger to easily dispose of trash, especially while in the back seat. Receptacles could be hung in various areas of the vehicle for use of all occupants, but the back seat is a common area of need for trash receptacles.

Parents and/or caretakers, especially, have issues with keeping automobiles clean when they have children in the backseat who are not able to properly dispose of trash without interrupting the parent or forcing the parent to look back, which can cause a safety issue. Therefore, a very real need exists for an attachable waste receptacle, appealing in design and function, which would inspire a backseat passenger—in many cases a child or another passenger—to dispose of his/her trash in a fun way, without the help of the driver.

### SUMMARY OF THE INVENTION

The present invention relates to a new form of waste receptacle that is 1) attachable to a seat; 2) is passenger-friendly in shape and design; and 3) is easily reachable by passengers in a car or other vehicle. The waste receptacle could also potentially contain pockets that would hold tissues, hand sanitizer, napkins, or other articles that could further help a passenger or child “clean up.”

In its most basic form, the invention comprises a waste receptacle housed within the shape of a stuffed animal, toy, mascot or other appropriate object that appeals to a child or other passenger, and encourages clean up. In the preferred embodiment of the invention, this receptacle attaches to the back of a car seat. The objective of the invention is to encourage a passenger sitting in front of the receptacle to reach out towards the receptacle and insert trash therein, without help from the driver or others in the car. In this manner, the passenger can “clean up” independently.

The invention contemplates that other items may be added to the receptacle in the shape of an animal, toy or object, to encourage clean up, including pockets on the interior or exterior of the toy, animal, or other object. These pockets may be designed to hold hand wipes, tissues, and other travel or clean-up accessories, to be easily accessed by the passenger while cleaning up and disposing of his/her trash in the vehicle.

Overall, this attachable passenger-friendly waste receptacle design greatly improves a passenger's ability to be self-sufficient while traveling, and substantially diminishes the chances of passenger distracting of the driver. In addition, the overall design encourages a child or other passenger to “have fun,” by cleaning up with “pal,” attached to the seat in front of him or her.

As such, the present design is a great improvement over inadequate, non-attachable, and/or non-passenger-friendly waste disposal receptacles presently being used in the automobile or vehicle setting.

### BRIEF DESCRIPTION OF THE DRAWINGS

FIG. 1 is a front elevational view of the attachable waste receptacle constructed in accordance with the preferred embodiment of the present invention, in the shape of an animal with its mouth closed;

FIG. 1A is top frontal view of the waste receptacle of FIG. 1, displaying the preferred embodiment of the invention, with the animal's mouth open and liner inserted.

FIG. 2 is a left side view of the receptacle; the right side view of the receptacle being a mirror-image.

FIG. 3 is a rear view of the attachable waste receptacle of FIG. 1.

FIG. 4 is a view of the liner that can be inserted and removed from the receptacle.

FIG. 5 is a close up front elevational view of the receptacle in the shape of an animal, with the animal's mouth open and liner removed.

FIG. 6 is a left side view of the liner being inserted into the receptacle in the shape of an animal.

### DETAILED DESCRIPTION OF THE INVENTION

Referring now to the invention in more detail, the attachable waste receptacle contemplated herein may be comprised of, but is not limited to, an attachable receptacle: 1) in the form of an animal: such as a dog, cat, elephant, dinosaur or any other animal; 2) a toy: such as train, car, or doll; or 3) any other object (e.g. a team mascot) that is appealing to passengers of a car or other mode of transportation.

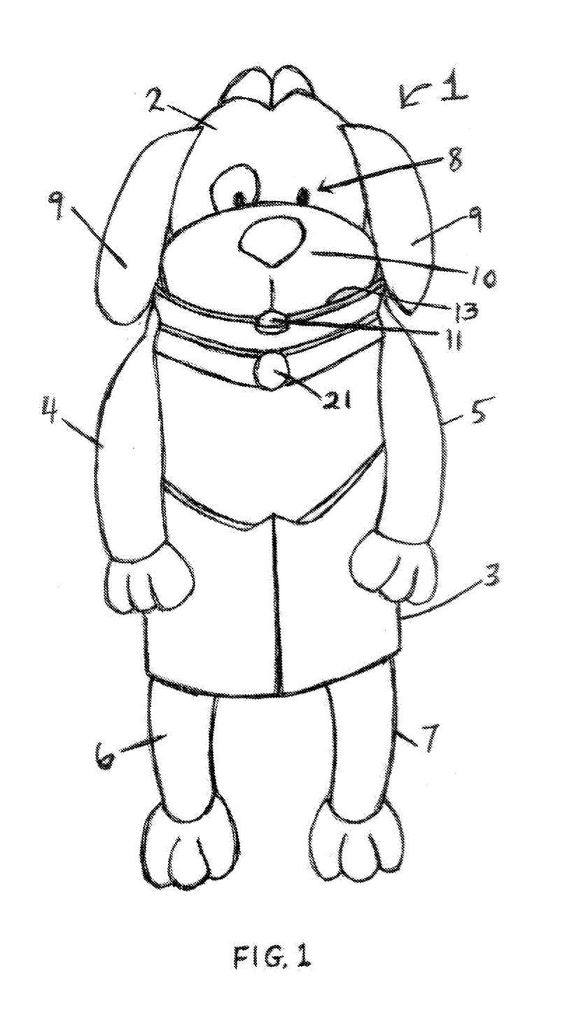

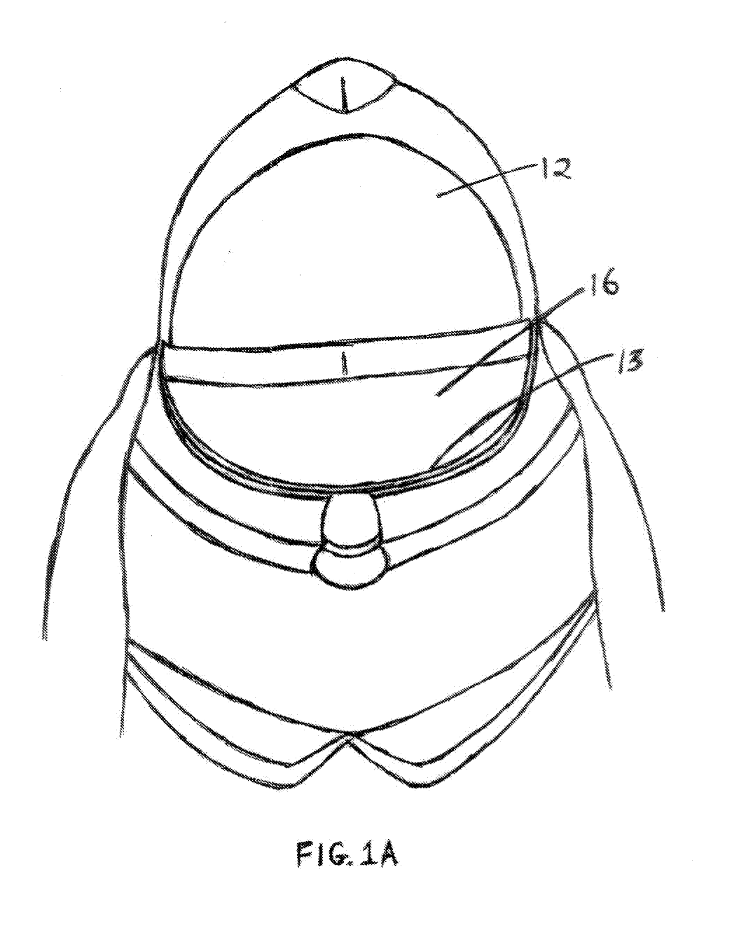

In FIG. 1 to FIG. 3 there is shown a preferred embodiment of the present invention, a passenger-friendly attachable waste receptacle, in the form of an animal. It is to be noted that the invention is by no means limited to this embodiment, and that other embodiments of the invention of the invention may also exist, as described above.

FIGS. 1-3 depict the preferred embodiment of the attachable waste receptacle from different views, as described above in the Description of the Drawings section.

Referring now to FIG. 1 in more detail, in the preferred embodiment displayed herein the attachable waste receptacle is comprised of a partially-stuffed animal (1). The animal (1) comprises a head section (2), a body section (3), arm sections (4) and (5) and leg sections (6) and (7). In further detail, the head section (2) further comprises eyes (8), ears (9), a snout (10), a tongue (11), and mouth section (12). In FIG. 1, mouth section (12) of the animal is depicted in the closed position, and it is not visible.

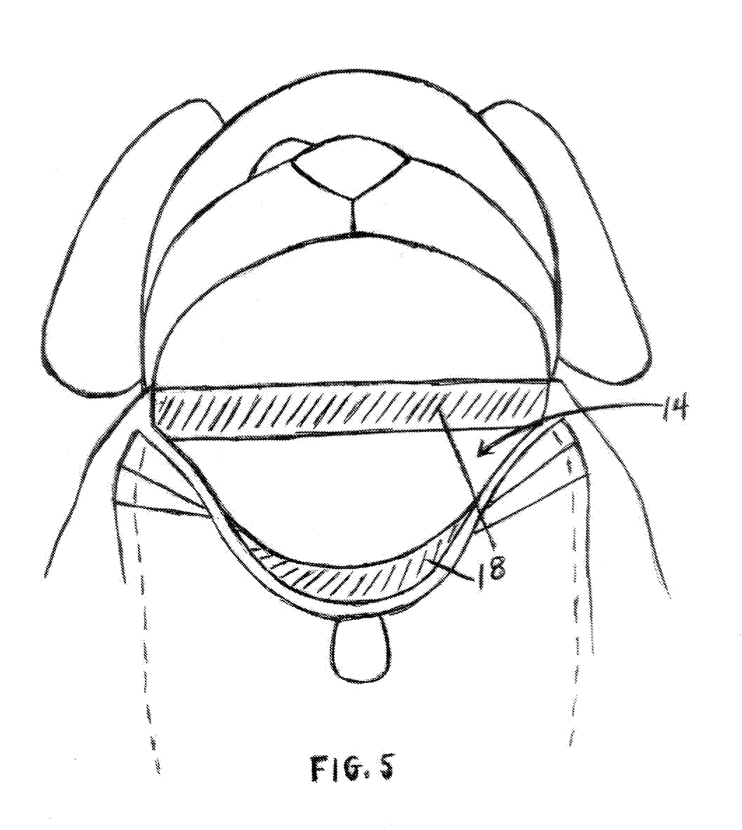

In further detail, as demonstrated in FIG. 1, the body section (3) of animal (1) further comprises a hollow interior receptacle section (14) that conforms to the general shape of the interior of the body section (3). Section (14) is not visible in FIG. 1, but is shown in FIG. 5. Arm sections (4) and (5) are attached to the top left and right sides of the body section (3), respectively, and leg sections (6) and (7) are attached to the left and right sides, respectively, of the bottom of the body section (3).

FIG. 1A is close-up representation of the animal (1) from FIG. 1, with the mouth section (12) in the “open” position and visible. This figure depicts the animal (1) with a liner (16) visible and attached to the interior hollow receptacle section (14) of animal (1). (See FIG. 5 for a view of the top of interior section (14).

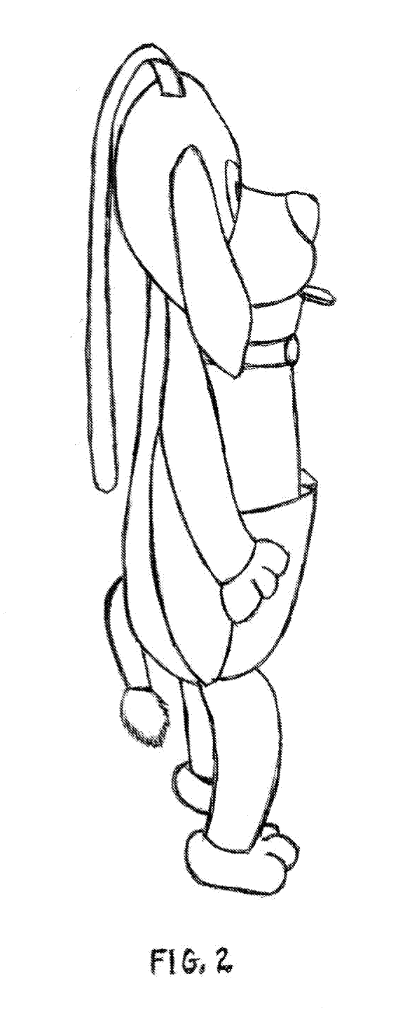

FIG. 2 shows the animal (1) from the left side; the right side is a mirror image. FIG. 2 depicts the animal with its mouth in the closed position.

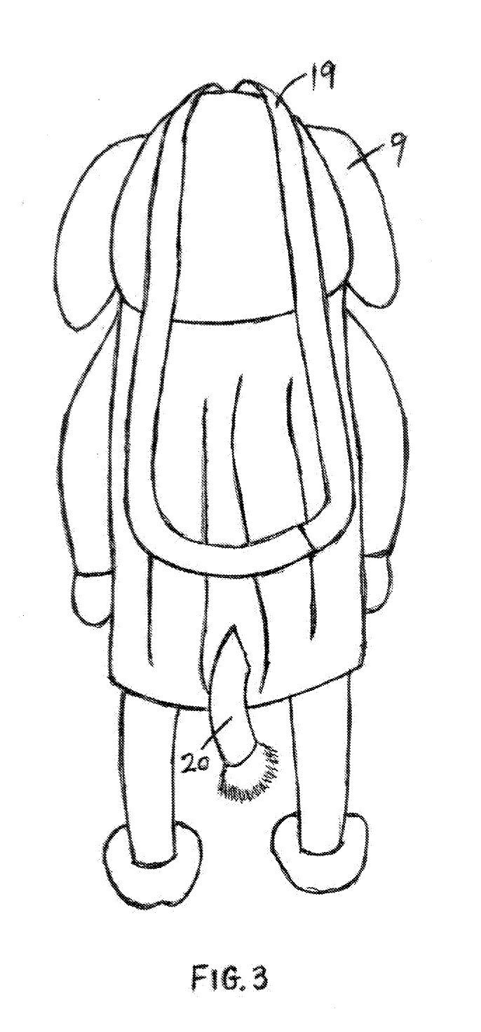

In FIG. 3, the rear view of the preferred embodiment is shown. The ears (9) are attached to the right and left side of the head section (2) of animal (1), securing means (19) are attached to the top of the head section (2), and a tail section (20) is attached to the lower bottom half of the rear exterior of body section (3).

In further detail, the method of opening the “mouth” of the animal (1), depicted in FIG. 1A, is described below. As shown in FIG. 1, under the animal's snout (10), the mouth portion (12) is secured to the interior front edge (13) of bottom portion (3). This mouth portion (12) is opened by pulling the tongue (11), which slightly protrudes at the bottom of the snout (10), downwards. By pulling downwards, one is able to pull body section (3) away from the head section (2) displaying the mouth portion (12) of head section (2) (as shown in FIG. 1A).

When the bottom portion (13) is pulled open, a liner (16) that is attached to the interior of the body section (3) becomes visible. This liner (16) is attached to and generally matches the volume and shape of the receptacle section (14) of the body section (3) of the animal (1) (as more clearly depicted in FIG. 5). This receptacle liner (16) lines the waste receptacle section (14) and holds trash when the liner (16) is properly inserted into the animal (1).

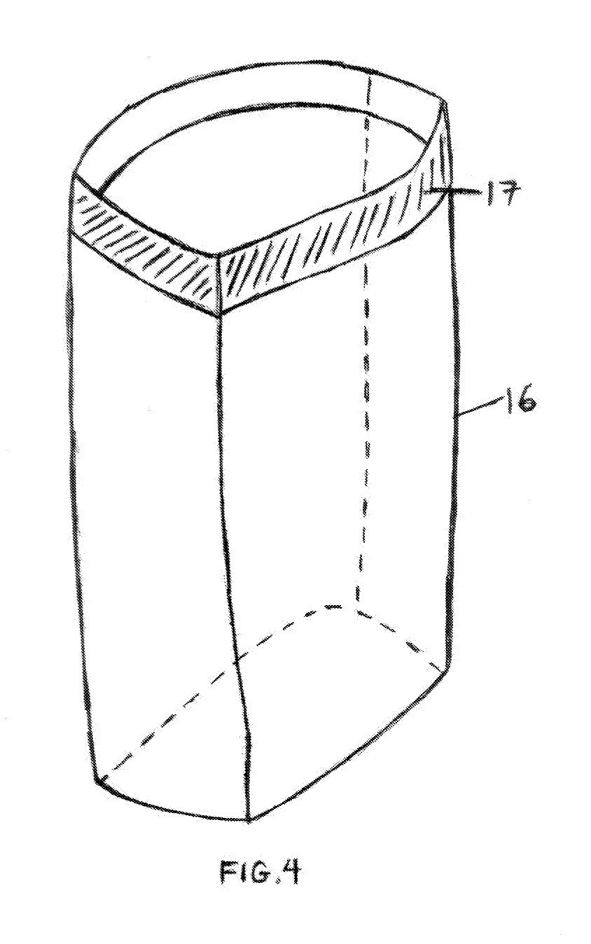

FIGS. 4-6 depict the receptacle liner, the attaching means for the liner (16) to the receptacle section (14) of the animal (1), and the method of inserting the liner (16) into the interior receptacle section (14).

In further detail, FIG. 4 depicts the liner (16) removed from the animal (1). Liner (16) comprises attaching means (17) along the top exterior rim of the liner (16), to allow the liner (16) to attach to the interior rim of the interior receptacle (14) of the body section (3) of the animal (1).

FIG. 5 depicts the attaching means (18), located along the front interior rim and the back interior rim of receptacle section (14), of animal (1), as well as the hollow interior receptacle section (14) of the animal (1).

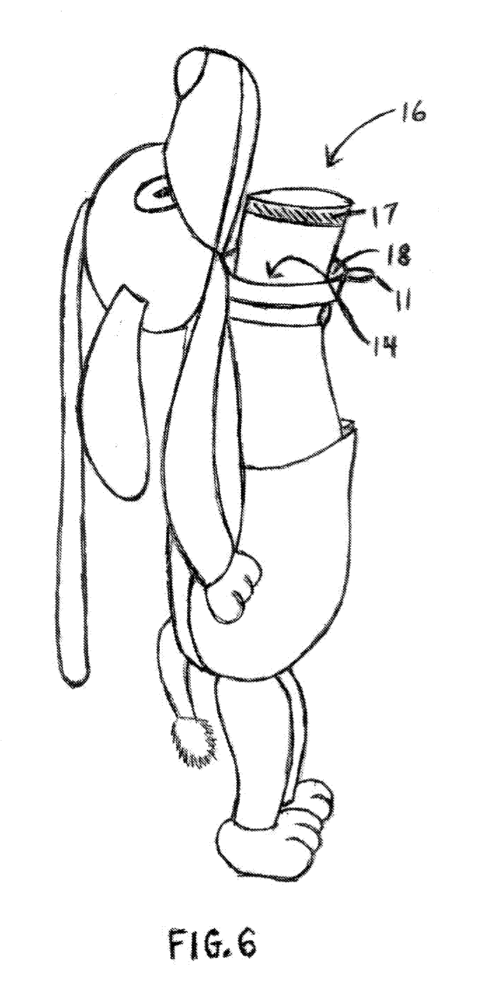

FIG. 6 depicts the step of inserting the liner (16) into the waste receptacle, and attaching the liner (16) to the animal (1). First, the liner (16) is inserted into the interior of body section (3) of the animal (1), and the interior of the liner (16) is pushed out in all directions, to frame the interior receptacle section (14) of the body section (3). Once the liner (16) is inserted into the body section (3), the attaching means (17) along the top exterior top edge of the liner (16) are attached to the attaching means (18) located along the back interior rim of body section (3) of the animal (1), and to the attaching means (18) located along the front interior rim of receptacle section (14). As such, the liner (16) is attached to the interior receptacle section (14) of the body section (3), creating a lined waste receptacle section (14). The liner (16) may be removed, by pulling the top edges of the liner away from the front and back of the interior receptacle section (14) of the animal (1). In this fashion a parent (or other user of the waste receptacle) can remove and clean the liner (16), after it is used or filled with trash.

As depicted in FIGS. 1-3, to allow for ease of use, in this preferred embodiment, the securing means (19) are attached to the top of the head section (2) of the animal (1) so that the securing means (19) can be wrapped around and/or otherwise secured to the edges of a seat, head rest, or other stationary object, thereby holding the attachable waste receptacle in place.

The construction details of the preferred embodiment of the invention, as shown in FIG. 1 to FIG. 6, include, but are not limited to, the following. The head section (2), body section (3), arm sections (4) and (5) and leg sections (6) and (7) of animal (1) may be made out of one or more of any series of material used to make a stuffed animal or toy or other passenger-friendly object, including but not limited to: fabric, yarn, plastic, felt, fur, textiles, or any other material that can be manipulated into a solid shape. Body section (3) is made of similar materials to those in head section (2). The eyes (8), nose (9), snout (10), tongue (11) and mouth (12) sections may be made of similar material to the other sections of the head (2) and body sections (3), including but not limited to those described above. Attaching means (17) and (18) may be made of any material that can be used to safely attach an item to another item, and that is relatively durable (and preferably washable), including but not limited to: velcro, zippers, buttons, snaps, hooks and loops, etc. Securing means (19) could be comprised of fabric straps, velcro, buckles, hooks or any other material that is functional for securely hanging or attaching the object to a seat. Tail section (20) may be comprised of fabric, fur, felt, yarn, plastic, and/or any other material suitable for use in the art for producing toys, stuffed animals, or other passenger-friendly object components.

Liner section (16) may be made of plastic, vinyl, lycra, or any other material that can hold a shape, and that is easy to insert and remove from the receptacle section (14) of animal (1). Liner (16) is preferably made of a washable material so that it can be kept clean, between uses. Optionally, disposable liners may also be inserted into liner (16) to make disposal of accumulated trash easier when traveling long distances and/or washing of the liner (16) is not practical or convenient.

Referring now to the method of making the invention, as represented in the preferred embodiment in FIG. 1 to FIG. 6, the animal (1) may be constructed as follows: Head section (2) may be constructed of fabric sections that are sewn together into a hollow head section that is then stuffed. The bottom section (3) is created by sewing two fabric sections together to create a hollow interior. The bottom section (3) is then sewn to head section (2), along a seam under the back of open mouth section (12) of head section (2). Remaining arm sections (4) and (5) and leg sections (6) and (7) are attached to the appropriate locations of the animal (1), as depicted in FIG. 1. Sections (8), (9), (10) and (11) may be glued, sewn or otherwise connected to animal (1). Mouth section (12) may be created by sewing or pasting felt to the bottom of head section (2), or otherwise distinguishing section (12) as a mouth section, as demonstrated in FIG. 1A.

Optionally, pockets may be added to the front, sides, or back of the interior or exterior of the animal (1), as depicted in FIGS. 1-3. Additionally, the securing means (19) and tail section (20) may be added to further distinguish the attachable waste receptacle as an animal (1). Finally, a medallion (21) may be added to give the animal (1) a unique personality, and may even read a unique name, to be chosen by a passenger, child, parent or purchaser of the attachable waste receptacle (in this embodiment, the animal (1)).

The advantages of the present invention include, without limitation, the ability of a driver to provide an easy to use attachable waste receptacle to the back of a car seat, to allow for ease of use by a backseat passenger. The receptacle can be removed and reattached as necessary. The interior liner can be removed and reattached inside the waste receptacle, as well. This invention allows for easy, unassisted cleanup of the backseat car area, by the passengers in the back seat.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. For instance, other means for opening and closing the opening for the deposit of trash have been contemplated (magnets, electronic means, etc.) In addition, the liner within the waste receptacle could be removed from the sides or bottom of the waste receptacle, and not just from a top of the receptacle. In addition, for any future creation of the attachable waste receptacle, the lined receptacle section could be on the inside or outside of the animal, object, toy, or other future version of the overall receptacle. The invention should therefore not be limited by the above described embodiment, method, and examples, but should include all embodiments and methods within the scope and spirit of the invention.

I claim:

1. A passenger-friendly attachable waste receptacle comprising:
A head section and a body section;
wherein said head section further comprises securing means; and
wherein said body section further comprises a hollow receptacle section and a liner;
wherein said liner generally conforms to the shape of said hollow receptacle section; and
wherein said liner is insertable and removable from said hollow receptacle section.

2. The receptacle of claim 1, wherein said liner attaches to said receptacle section via attaching means on said liner and on said receptacle section.

3. The receptacle of claim 2, wherein said securing means is capable of attaching said receptacle to the back of a car seat or other stationary object.

4. The receptacle of clam 3, wherein said attaching means are in the form of velcro strips.

5. The receptacle of claim 3, wherein said securing means are in the form of fabric straps.

6. The receptacle of claim 3, wherein said body section further comprises pockets for storing additional clean-up items.
